(19) United States
(12) Patent Application Publication
(10) Pub. No.: US 2007/0291371 A1
(43) Pub. Date: Dec. 20, 2007

(54) Synergetically enhanced multiple-layer optical film and process thereof

(76) Inventor: Ching-Bin Lin, Taipei (TW)

Correspondence Address: Ching-Bin Lin, P. O. Box 55-846, Taipei, 104, omitted

(21) Appl. No.: 11/454,395

(22) Filed: Jun. 19, 2006

(51) Int. Cl. G02B 27/10

(52) U.S. Cl. 359/625

(57) ABSTRACT

A multiple-layer optical film comprises: a supporting layer; a printable intermediate thin layer formed on the supporting layer; and an upper structured-surface or upper prismatic layer formed on the printable intermediate layer. The intermediate thin layer is imprinted with a plurality of notches recessed in the intermediate thin layer to be respectively engaged with a plurality of lower protrusions protruding downwardly from the upper layer for firmly interlocking the upper layer with the intermediate layer which is formed on the supporting layer.

### BACKGROUND OF THE INVENTION

U.S. patent application Ser. No. 11/358,349 also filed by the same inventor of this application disclosed an optical film including: a structured-surface layer (2) and a supporting layer (5) bonded with the structured-surface layer (2), wherein the structured-surface layer (2) includes a plurality of upper prismatic or structured protrusions (3) formed on an upper portion of the structured-surface layer (2) and having a plurality of lower prismatic protrusions or lower protrusions (4) formed on a bottom portion of the structured-surface layer (2). The supporting layer (5) is recessed with a plurality of notches (6) to be engaged with the lower protrusions (4) of the structured-surface layer (2) to thereby firmly interlock the structured-surface layer (2) with the supporting layer (5) to increase the film strength and also to increase the brightness of the optical film.

The supporting layer (5) is made of thermoplastic resin including PET. When forming the notches (6) in the supporting layer (5), the thermoplastic layer should be heated above its glass transition temperature for softening the resin in order to be molded for forming or shaping the notched layer (5). Then, it must be cooled down and released from the mold, causing a very complex procedure and consuming longer production time.

Meanwhile, it is difficult to obtain a homogeneous micro-structure as recessed in the thermoplastic resin film or layer when the product area is very large. It is also difficult to microminiaturize the micro-structure of the layer, thereby limiting its industrial or commercial uses.

The present inventor has found the drawbacks of the prior invention and invented the present multiple-layer optical film easily and economically produced.

### SUMMARY OF THE INVENTION

The object of the present invention is to provide a multiple-layer optical film comprising: a supporting layer; a printable intermediate thin layer formed on the supporting layer; and an upper structured-surface or upper prismatic layer formed on the printable intermediate layer; with the intermediate thin layer imprinted with a plurality of notches recessed in the intermediate thin layer to be respectively engaged with a plurality of lower protrusions protruding downwardly from the upper layer for firmly interlocking the upper layer with the intermediate layer which is formed on the supporting layer.

Since the intermediate layer is made of photo-curing or thermosetting resin, it can be easily quickly imprinted with the notches during the molding process, thereby producing interlocked multiple-layer optical films in a quicker way and at a lower production cost.

### BRIEF DESCRIPTION OF THE DRAWING

FIG. 1 is a sectional drawing showing the multiple layers of the optical film of the present invention.

FIG. 2 is a sectional drawing showing a plurality of lower protrusions successively formed in the optical film of the present invention.

FIG. 3 shows another preferred embodiment of the present invention.

FIG. 4 shows still another preferred embodiment of the present invention.

FIG. 5 shows further preferred embodiment of the present invention.

FIG. 6 shows still further preferred embodiment of the present invention.

### DETAILED DESCRIPTION

As shown in FIG. 1, an optical film or prism sheet 1 of the present invention comprises: a supporting layer 5; a printable intermediate layer (or thin layer) 7 formed on the supporting layer 5; and an upper structured-surface layer or upper prismatic layer 2 formed on the intermediate layer 7.

The upper prismatic layer 2 includes a plurality of upper prismatic protrusions 3, each upper prismatic protrusion 3 formed by two upper prism surfaces 3a, 3b tapered upwardly to define an angle therebetween.

The supporting layer 5 may be made of polyethylene terephthalate (PET), polycarbonate (PC), and other suitable transparent materials.

The intermediate layer 7 and the upper prismatic layer 2 may be respectively made of photo-curing resin (including ultraviolet or UV curable resin), and thermosetting resin.

The numerals N1, N2, N3 respectively indicate the refractive indices of the upper layer 2, the intermediate layer 7 and the supporting layer 5, being not limited in the present invention. The intermediate layer 7 and the supporting layer 5 may have the same refractive index (N2=N3). However, the upper layer 2 has the refractive index N1 which is preferably larger than that (N2) of the intermediate layer 2(N1>N2), or larger than that (N3) of the supporting layer 5 (N1>N3).

The optical film of the present invention may be made by the process comprising the steps of:
1. Homogeneously coating a photo-curing resin or thermosetting resin of the intermediate layer on the supporting layer; imprinting the intermediate layer with a plurality of notches recessed in the intermediate layer; and hardening or curing the resin of the intermediate layer by light radiation (such as ultraviolet radiation) or heating by a heater for forming the intermediate layer having the plurality of notches 6 recessed therein; and
2. Forming or imprinting a photo-curing resin or thermosetting resin of the upper layer 2 on the intermediate layer 7 to fill, drain, impregnate or flow the resin of the upper layer 2 into the notches 6 in the intermediate layer 7; hardening or curing the resin of the upper layer 2 by ultraviolet radiation or heating by a heater to form a plurality of the lower protrusions 4 respectively protruding downwardly from the upper layer 2 to be respectively engaged with the notches 6 in the intermediate layer 7 so as to firmly interlock the upper layer 2 with the intermediate layer 7 which is formed on the supporting layer 5.

In order to enhance the bonding strength between the supporting layer 5 and the intermediate layer 7, the supporting layer 5 may be pre-coated with a primer coating, and then coated with the photo-curing or thermosetting resin on the supporting layer 5 for forming or imprinting the notches 6 in the intermediate layer 7.

The shapes of the lower protrusion 4 are not limited in the present invention. The lower protrusion 4 may be formed as a triangular shape tapered downwardly from the upper layer 2. Other shapes such as rectangular, round or spherical shapes may also be used in the present invention.

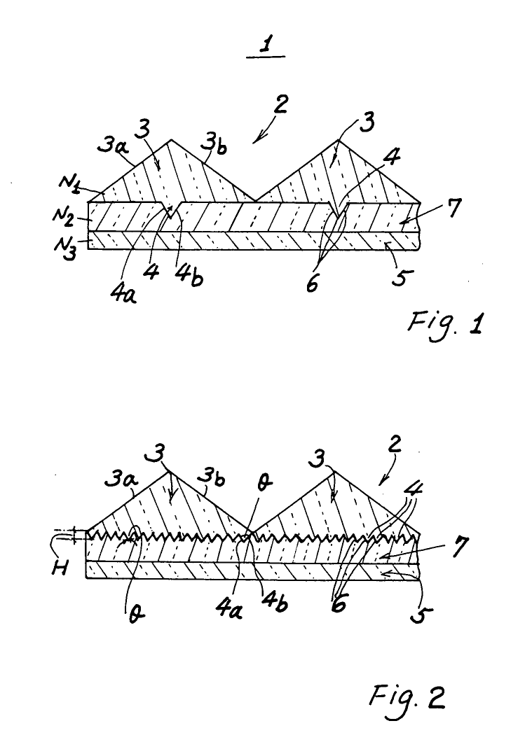

As shown in FIG. 2, each lower protrusion 4 has a height H ranging from 2 microns through 5 microns. Each lower protrusion 4 is formed as a triangular shape having the two prism surfaces 4a, 4b tapered downwardly to define an acute angle θ ranging from 10˜40°.

The lower protrusions 4 may be successively or continuously formed on a bottom portion of the upper layer 2. Or, the lower protrusions 4 may be intermittently formed on a bottom portion of the upper layer 2. The more number the lower protrusions 6 are provided, the better optical properties the optical film can be enhanced.

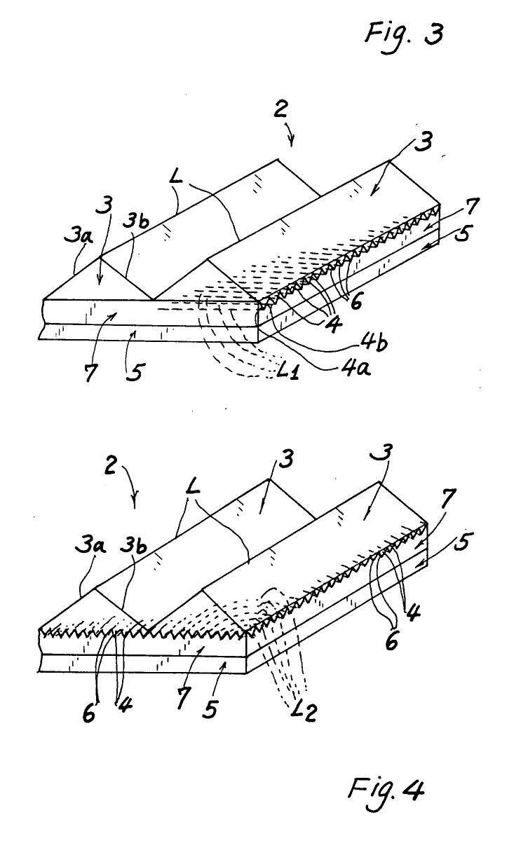

As shown in FIG. 3, each upper prismatic protrusion 3 includes the two prism surfaces 3a, 3b tapered upwardly to be intersected at an upper ridge line (or apex line) L, while each lower protrusion 4 having its two prism surfaces 4a, 4b tapered downwardly to be intersected at a lower ridge line L1, with the upper ridge line L being projectively perpendicular to the lower ridge line L1.

Naturally, the above-mentioned upper ridge line L may also be parallel to the lower ridge line L1.

Other orientations for the lay-out of the upper ridge line or lower ridge line may be modified in accordance with the present invention.

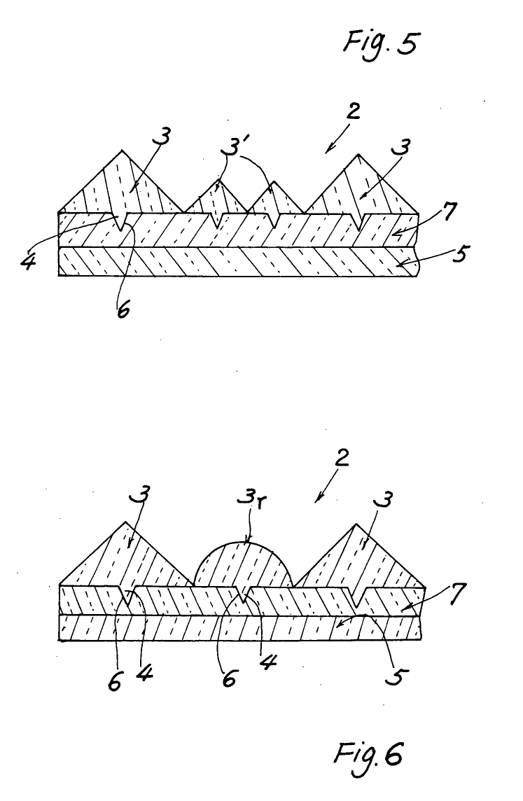

As shown in FIG. 4, the lower ridge line L2 has been modified to be an arcuate or curve line, all lines L2 being concentrically formed on a bottom of the upper layer 2. As shown in FIG. 5, some upper prismatic protrusions 3′ are each lower than the other upper prismatic protrusions 3, thereby forming upper prismatic protrusions 3, 3′ with different heights. The high protrusions and the low protrusions may be alternatively formed on the intermediate layer 7 above the supporting layer 5.

As shown in FIG. 6, some upper prismatic protrusions have been modified to be round protrusions 3r or semi-cylindrical protrusions. Other shapes of the upper protrusions 3 may be further modified in the present invention.

The present invention has the following advantages superior to the prior application as mentioned in the paragraph of the “Background of the Invention” in this disclosure:
1. The production time can be shortened;
2. The micro-structured pattern may be more uniformly formed in the layers of the optical film, thereby enhancing the light uniformity and brightness of the optical film;
3. The structure or pattern of the optical film can be easily microminiaturized; and
4. The production quality and efficiency of the optical film can be improved, and the production cost can be decreased accordingly.

Sine the intermediate layer 7 made of photo-curing or thermosetting resin of the present invention is a thin layer, as compared with the supporting layer having greater thickness of the prior application or prior art, the “thin-layer” photo-curing or thermosetting resin of the intermediate layer 7 can be quickly imprinted or formed with the patterns or notches 6 on the intermediate layer 7 which can then be quickly hardened or cured by UV radiation or by heating, thereby shortening the total production time and cost of this invention in comparison with the prior art which requires longer time for rising or lowering the glass transition temperature of the resin during the molding or demolding operations.

The present invention may be furhter modified without departing from the spirit and scope of the present invention.

I claim:

1. A multiple-layer optical film comprising:
a supporting layer;
a printable intermediate layer formed on said supporting layer and having a plurality of notches formed in an upper portion of
said intermediate layer; and an upper structured-surface layer formed on said intermediate layer and having a plurality of lower protrusions protruding downwardly from said upper structured-surface layer to engage each said lower protrusion of said upper structured-surface layer with each said notch of said intermediate layer for interlocking said upper structured-surface layer with said intermediate layer as formed on said supporting layer to form a multiple-layer optical film.

2. An optical film according to claim 1, wherein each said lower protrusion is formed as a triangular shape tapered downwardly from said upper structured-surface layer; and each said notch formed as a triangular shape recessed and tapered downwardly in said intermediate layer.

3. An optical film according to claim 1, wherein said upper structured-surface layer includes a plurality of upper prismatic protrusions protruding upwardly from said upper structured-surface layer.

4. An optical film according to claim 1, wherein said supporting layer is made of transparent thermoplastic resin including polyethylene terephthalate and polycarbonate.

5. A process for making multiple-layer optical film as set forth in claim 1 comprising the steps of:
A. Homogeneously coating a photo-curing resin or thermosetting resin of the intermediate layer on the supporting layer; imprinting the intermediate layer with a plurality of notches recessed in the intermediate layer; and curing the resin of the intermediate layer by light radiation or by heating for forming the intermediate layer having the plurality of notches recessed therein; and
B. Forming or imprinting a photo-curing resin or thermosetting resin of the upper layer on the intermediate layer to fill the resin of the upper layer into the notches in the intermediate layer; curing the resin of the upper layer by ultraviolet radiation or by heating to form a plurality of the lower protrusions respectively protruding downwardly from the upper layer to be respectively engaged with the notches in the intermediate layer to firmly interlock the upper layer with the intermediate layer which is formed on the supporting layer to form a multiple-layer optical film.
